(19) United States
(12) Patent Application Publication
(10) Pub. No.: US 2026/0300624 A1
(43) Pub. Date: Oct. 1, 2026

(54) Reconciling Speaker Permutation In Longform Speaker Diarization with Sequence Processing Neural Networks

(71) Applicant: Google LLC, Mountain View, CA (US)

(72) Inventors: Quan Wang, Hoboken, NJ (US); Neeraj Gaur, Jersey City, NJ (US); Guanlong Zhao, Union City, NJ (US); Parisa Haghani, Atlanta, GA (US)

(73) Assignee: Google LLC, Mountain View, CA (US)

(21) Appl. No.: 19/096,629

(22) Filed: Mar. 31, 2025

(51) Int. Cl. G06F 40/284; G10L 15/26; G10L 17/04

(52) U.S. Cl. CPC G06F 40/284; G10L 15/26; G10L 17/04

(57) ABSTRACT

A method includes obtaining a plurality of audio data segments characterizing a conversation between two or more speakers. For each respective audio data segment, the method includes generating a corresponding short-form diarized transcript of a respective portion of the conversation. The corresponding short-form diarized transcript includes a respective sequence of terms and a respective one or more speaker tokens attributing each of the sequence terms to a corresponding speaker identity. The method includes generating a reconciled long-form diarized transcript based on the corresponding short-form diarized transcript generated for each respective audio data segment. A sequence processing neural network generates the reconciled diarized transcript by, for one of the corresponding short-form diarized transcripts, permuting a first speaker token and a second speaker token of the at least one of the corresponding short-form diarized transcripts.

### TECHNICAL FIELD

This disclosure relates reconciling speaker permutation in longform speaker diarization with sequence processing neural networks.

### BACKGROUND

Speaker diarization is the process of partitioning an input audio stream into homogeneous segments according to speaker identity. In an environment with multiple speakers, speaker diarization answers the question “who is speaking when” and has a variety of applications including multimedia information retrieval, speaker turn analysis, audio processing, and automatic transcription of conversation speech to name a few. For example, speaker diarization involves the task of annotating speaker turns in a conversation by identifying that a first segment of an input audio stream is attributable to a first human speaker (without particularly identifying who the first human speaker is), and a second segment of the input audio stream is attributable to a different second human speaker (without particularly identify who the second human speaker is), a third segment of the input audio stream is attributable to the first human speaker, etc.

### SUMMARY

One aspect of the disclosure provides a computer-implemented method that when executed on data processing hardware causes the data processing hardware to perform operations for reconciling speaker permutation in longform speaker diarization. The operations include obtaining a plurality of audio data segments characterizing a conversation between two or more speakers. For each respective audio data segment, the operations include generating, using a speaker diarization model, a corresponding short-form diarized transcript of a respective portion of the conversation. The corresponding short-form diarized transcript includes a respective sequence of terms and a respective one or more speaker tokens attributing each of the sequence terms to a corresponding speaker identity. The operations include generating, using a sequence processing neural network, a reconciled long-form diarized transcript based on the corresponding short-form diarized transcript generated for each respective audio data segment. The sequence processing neural network generates the reconciled diarized transcript by, for one of the corresponding short-form diarized transcripts, permuting a first speaker token and a second speaker token of the at least one of the corresponding short-form diarized transcripts.

Implementations of the disclosure may include one or more of the following optional features. In some implementations, the one of the corresponding short-form diarized transcript includes a first sequence of terms, the first speaker token attributing a first portion of the first sequence of terms to a first speaker identity, and the second speaker token attributing a second portion of the sequence of terms to a second speaker identity. In these implementations, another one of the corresponding short-form diarized transcript may include a second sequence of terms, the first speaker token attributing a first portion of the second sequence of terms to the first speaker identity, and the second speaker token attributing a second portion of the second sequence of terms to the second speaker identity. Here, the first speaker token and the second speaker token are not consistent across the one of the corresponding short-form diarized transcript and the other one of the corresponding short-form diarized transcript. The reconciled diarized transcript may permute the first speaker token and the second speaker token such that the first speaker token and the second speaker token are consistent across the one of the corresponding short-form diarized transcript and the other one of the corresponding short-form diarized transcript.

In some examples, the sequence processing neural network permutes the first speaker token and the second speaker token of the one of the corresponding short-form diarized transcripts based on semantic context spanning across the conversation. In some implementations, the operations further include: for each respective audio data segment, generating, using an automatic speech recognition model, a corresponding transcription including one or more terms; and for each respective term of the one or more terms obtaining prior diarized transcripts and generating, using the sequence processing neural network, a corresponding diarized transcript based on the respective term and the prior diarized transcript. Here, the operations may further include obtaining a text input representing notes taken during the conversation where generating the corresponding diarized transcript is further based on the text input. In these implementations, the operations may further include timestamping the text input with a time of capture relative to the conversation. The operations may further include diarizing the text input using the sequence processing neural network. Here, the operations may further include annotating, using the sequence processing neural network, the text input to the long-form diarized transcript.

Another aspect of the disclosure provides a system that includes data processing hardware and memory hardware storing instructions that when executed on the data processing hardware causes the data processing hardware to perform operations. The operations include obtaining a plurality of audio data segments characterizing a conversation between two or more speakers. For each respective audio data segment, the operations include generating, using a speaker diarization model, a corresponding short-form diarized transcript of a respective portion of the conversation. The corresponding short-form diarized transcript includes a respective sequence of terms and a respective one or more speaker tokens attributing each of the sequence terms to a corresponding speaker identity. The operations include generating, using a sequence processing neural network, a reconciled long-form diarized transcript based on the corresponding short-form diarized transcript generated for each respective audio data segment. The sequence processing neural network generates the reconciled diarized transcript by, for one of the corresponding short-form diarized transcripts, permuting a first speaker token and a second speaker token of the at least one of the corresponding short-form diarized transcripts.

Implementations of the disclosure may include one or more of the following optional features. In some implementations, the one of the corresponding short-form diarized transcript includes a first sequence of terms, the first speaker token attributing a first portion of the first sequence of terms to a first speaker identity, and the second speaker token attributing a second portion of the sequence of terms to a second speaker identity. In these implementations, another one of the corresponding short-form diarized transcript may include a second sequence of terms, the first speaker token attributing a first portion of the second sequence of terms to the first speaker identity, and the second speaker token attributing a second portion of the second sequence of terms to the second speaker identity. Here, the first speaker token and the second speaker token are not consistent across the one of the corresponding short-form diarized transcript and the other one of the corresponding short-form diarized transcript. The reconciled diarized transcript may permute the first speaker token and the second speaker token such that the first speaker token and the second speaker token are consistent across the one of the corresponding short-form diarized transcript and the other one of the corresponding short-form diarized transcript.

In some examples, the sequence processing neural network permutes the first speaker token and the second speaker token of the one of the corresponding short-form diarized transcripts based on semantic context spanning across the conversation. In some implementations, the operations further include: for each respective audio data segment, generating, using an automatic speech recognition model, a corresponding transcription including one or more terms; and for each respective term of the one or more terms obtaining prior diarized transcripts and generating, using the LLM, a corresponding diarized transcript based on the respective term and the prior diarized transcript. Here, the operations may further include obtaining a text input representing notes taken during the conversation where generating the corresponding diarized transcript is further based on the text input. In these implementations, the operations may further include timestamping the text input with a time of capture relative to the conversation. The operations may further include diarizing the text input using the sequence processing neural network. Here, the operations may further include annotating, using the sequence processing neural network, the text input to the long-form diarized transcript.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematic views of an example system that executes a joint speech recognition and speaker diarization model.

FIG. 2 is a schematic view of an example speaker diarization model.

FIG. 3 is a schematic view of an example automatic speech recognition model.

FIG. 4 is a flowchart of an example arrange of operations for a computer-implemented method of reconciling speaker permutation in longform speaker diarization.

FIG. 5 is a schematic view of an example computing device that may be used to implement the systems and methods described herein.

Like reference symbols in the various drawings indicate like elements.

### DETAILED DESCRIPTION

Speaker diarization, the process of identifying who spoke when in an audio recording. This involves partitioning an audio stream into segments based on speaker identity. Thus, speaker diarization is important for analyzing long-form audio like meetings, phone calls, and videos. However, hardware and software limitations often prevent supervised speaker diarization models from processing such lengthy audio in its entirety during both training and evaluation. As a result, many models are trained on shorter audio segments that fit within hardware memory constraints. Segmentation introduces a challenge during inference known as the “speaker permutation problem.” When audio is divided, the speaker labels assigned within each segment are arbitrary and may not align across segments. For instance, “speaker 1” in one segment may not be the same person as “speaker 1” in another segment. This inconsistency makes it difficult to track individual speakers throughout the entire recording. Current approaches address this inconsistency using clustering algorithms based on speaker embedding vectors, which are considered biometric representations. However, the use of such biometric data raises legal and ethical concerns, as regulations around collecting and using biometric identifiers like voice prints are becoming increasingly stringent. Consequently, balancing the benefits of speaker diarization with privacy and data protection considerations is essential.

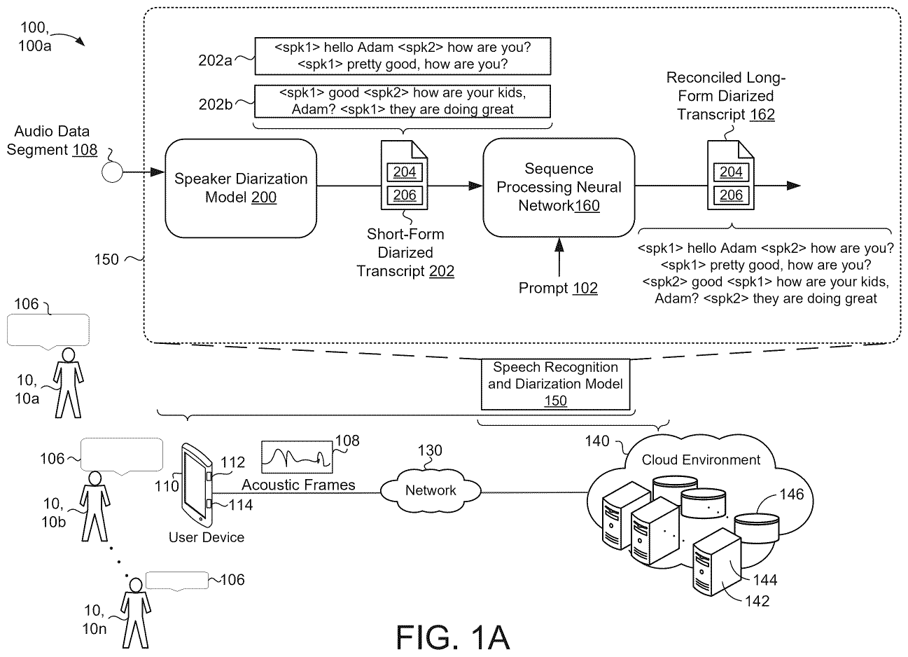

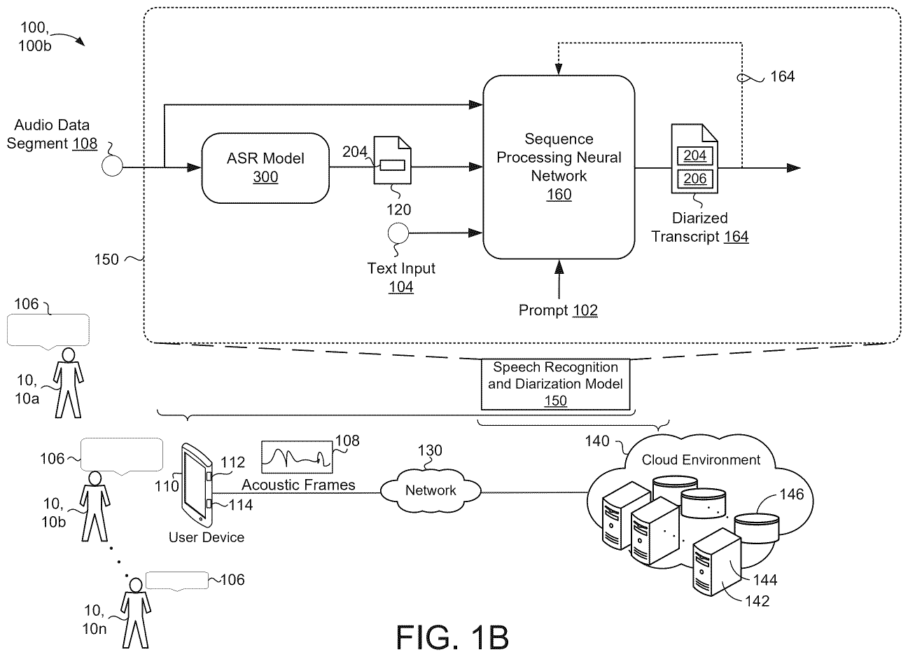

Referring to FIGS. 1A and 1, a system 100 includes a user device 110 capturing speech utterances 106 spoken by multiple speakers (e.g., users) 10, 10a-n during a conversation and communicating with a remote system 140 via a network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). The user device 110 and/or the remote system 140 execute a joint speech recognition and speaker diarization model 150.

The user device 110 includes data processing hardware 112 and memory hardware 114. The user device 110 may include an audio capture device (e.g., microphone) for capturing and converting the speech utterances 106 (also referred to as simply “utterances 106”) from the multiple speakers 10 into the sequence of acoustic frames 108 (e.g., input audio data). In some implementations, the user device 110 is configured to execute a portion of the joint speech recognition and speaker diarization model 150 locally (e.g., using the data processing hardware 112) while a remaining portion of the joint speech recognition and speaker diarization model 150 executes on the remote system 140 (e.g., using data processing hardware 144). Alternatively, the joint speech recognition and speaker diarization model 150 may execute entirely on the user device 110 or remote system 140. The user device 110 may be any computing device capable of communicating with the remote system 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

In the example shown, the multiple speakers 10 and the user device may be located within an environment (e.g., a room) where the user device 110 is configured to capture and convert the speech utterances 106 spoken by the multiple speakers 10 into the sequence of acoustic frames 108. For instance, the multiple speakers 10 may correspond to co-workers having a conversation during a meeting and the user device 110 may record and convert the speech utterances 106 into the sequence of acoustic frames 108. In turn, the user device 110 may provide the sequence of acoustic frames 108 to the joint speech recognition and speaker diarization model 150.

In some examples, at least a portion of the speech utterances 106 conveyed in the sequence of acoustic frames 108 are overlapping such that, at a given instant in time, two or more speakers 10 are speaking simultaneously. Notably, a number N of the multiple speakers 10 may be unknown when the sequence of acoustic frames 108 are provided as input to the joint speech recognition and speaker diarization model 150 whereby the joint speech recognition and speaker diarization model 150 predicts the number N of the multiple speakers 10. In some implementations, the user device 110 is remotely located from the one or more of the multiple speakers 10. For instance, the user device 110 may include a remote device (e.g., network server) that captures speech utterances 106 from the multiple speakers 10 that are participants in a phone call or video conference. In this scenario, each speaker 10 would speak into their own user device 110 (e.g., phone, radio, computer, smartwatch, etc.) that captures and provides the speech utterances 106 to the remote user device for converting the speech utterances 106 into the sequence of acoustic frames 108. Of course in this scenario, the speech utterances 106 may undergo processing at each of the user devices 110 and be converted into a corresponding sequence of acoustic frames 108 that are transmitted to the remote user device which may additionally process the sequence of acoustic frames 108 provided as input to the joint speech recognition and speaker diarization model 150.

Referring now specifically to FIG. 1A, in some implementations, the joint speech recognition and speaker diarization model 150 of a first example system 100, 100a is configured to receive a sequence of acoustic frames (i.e., plurality of audio data segments) 108 that corresponds to captured speech utterances 106 spoken by the multiple speakers 10 during the conversation and generate, at each of a plurality of output steps, diarized transcripts 202, 162. The diarized transcripts 202, 162 include a sequence of terms 204 and one or more speaker tokens 206. As will become apparent, the sequence of terms 205 indicate “what” was spoken during the conversation and the speaker tokens 206 indicate “who” spoke each term 204. In some examples, the speaker tokens 206 include word-level results that represent who spoke each word/wordpiece rather than frame-level results that represent who was speaking during each frame of the sequence of acoustic frames 108. In other examples, the speaker tokens 206 include frame-level results that represent who was speaking during each frame of the sequence of acoustic frames 108.

In some implementations, the joint speech recognition and speaker diarization model 150 includes a speaker diarization model 200 and a sequence processing neural network 160. In some examples, the sequence processing neural network 160 includes a large language model (LLM). For simplicity, the present disclosure will refer to the sequence processing neural network 160 as an LLM, however, the sequence processing neural network 160 may include other types of sequence processing neural networks other than LLMs without departing from the scope of the present disclosure. The speaker diarization model 200 is trained to generate short-form diarized transcripts 202 for each respective audio data segment 108. Notably, the speaker diarization model 200 generates each corresponding short-form diarized transcript 202 independently from each other short-form diarized transcript 202. The independent generation is a key characteristic of the speaker diarization model 200 and has significant implications for how the speaker diarization model 200 processes audio data. In particular, the speaker diarization model 200 generates each short-form diarized transcript 202 in isolation, without considering the information or context from other short-form diarized transcripts 202. This means that the speaker diarization model 200 does not maintain any memory or understanding of previous segments or speaker turns when processing a new segment. Consequently, the speaker diarization model 200 may assign different speaker tokens 206 to the same speaker across different segments, leading to inconsistencies in speaker labeling throughout the conversation. For instance, the speaker diarization model 200 may label the same speaker as “<spk1>” in one segment and “<spk2>” in another segment, even if the same individual is speaking. This inconsistency arises because the speaker diarization model 200 lacks the ability to link speaker identities across different segments, relying on local acoustic features within each segment to make speaker assignments. The lack of global context may result in mislabeling speakers, especially when dealing with long conversations or situations where speaker characteristics vary over time.

Thus, for each respective audio data segment 108 of the plurality of audio data segments, the speaker diarization model 200 generates a corresponding short-form diarized transcript 202 of a respective portion of the conversation. Each corresponding short-form diarized transcript 202 includes a respective sequence of terms 204, representing the recognized speech, and a respective one or more speaker tokens 206 attributing each of the sequence of terms 204 to a corresponding speaker identity. These speaker tokens 206 may take various forms. In one implementation, the speaker tokens 206 are discrete markers embedded within the sequence of terms 204, directly assigning each term 204 to a speaker identity. For instance, a speaker token 206 “[Speaker A]” may be assigned to one or more terms spoken by Speaker A. Alternatively, the speaker tokens 206 may be frame-level assignments, where each frame of the audio data segments is associated with a speaker identity. may be markers that assign each term 204 within the sequence of terms 204 to a specific speaker identity. Alternatively, the speaker tokens 206 may be assigned to each frame indicating which speaker identity was speaking during each frame. In other examples, the speaker tokens 206 includes speaker turn tokens, which denote the initiation or cessation of a speaker speaking. For instance, a speaker token “[Speaker A]” preceding a series of terms 204 would indicate that those terms 204 were spoken by Speaker A.

In the example shown, the speaker diarization model 200 generates a first short-form diarized transcript 202a and a second short-form diarized transcript 202b. The first short-form diarized transcript 202a includes “<spk1> hello Adam <spk2> how are you <spk1> pretty good, how are you?” The second short-form diarized transcript 202b includes “<spk1> good <spk2> how are your kids, Adam?<spk1> they are doing great.” Notably, in this example, the speaker tokens 206 correctly identify the transition of speakers within each short-form diarized transcript 202, but the speaker tokens 206 are not consistent across the first and second short-form diarized transcripts 202a, 202b. That is, the speaker diarization model 200, while accurately detecting speaker turns within individual segments, may assign arbitrary and inconsistent speaker identifiers, such as “<spk1>” and “<spk2>”, which do not maintain a uniform identification across multiple audio data segments 108. This inconsistency may manifest as the same physical speaker 10 being labeled as “<spk1>” in one segment and “<spk2>” in another, or even a third speaker token 206 in a subsequent segment.

More specifically, the first short-form diarized transcript 202a attributes “hello Adam” to “<spk1>” while the second short-form diarized transcript attributes “how are your kids, Adam?” to “<spk2>.” In a two-person conversation, it is clear that both of these segments are spoken by the same speaker (e.g., speaker talking with Adam) and not different speakers. This inconsistency arises because the speaker diarization model 200, operating on short audio segments 108, lacks the global context necessary to maintain consistent speaker identities throughout the entire conversation. For instance, for a conversation that continues for an hour, the speaker diarization model 200 may generate hundreds of short-form diarized transcripts 202, each with potentially different and unrelated speaker token 206. As a result, it is very difficult for the speaker diarization model 200 to accurately reconstruct the entire conversation with consistent speaker tokens 206.

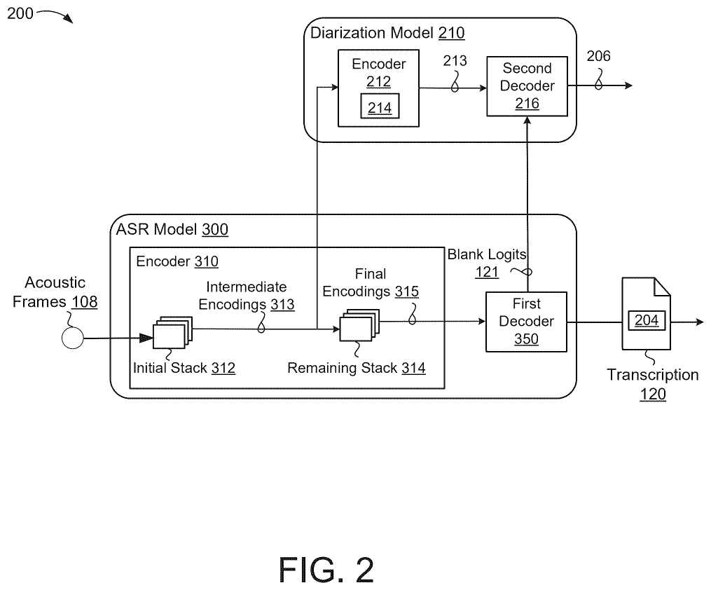

Referring to FIG. 2, in some implementations, the speaker diarization model 200 includes an automatic speech recognition (ASR) model 300 that has an audio encoder 310 and a first decoder 350, and a diarization model 210 that has a diarization encoder 212 and a second decoder 216. Notably, the first decoder 350 is independent and separate from the second decoder 216. That is, the first decoder 350 includes a respective set of parameters and the second decoder 216 includes a different respective set of parameters. Here, only two speakers (e.g., a first speaker 10, 10a and a second speaker 10, 10b) are participating in the conversation for the sake of clarity only, as it is understood that any number of speakers 10 may speak during the conversation. The ASR model 300 is configured to generate speech recognition results 120 representing “what” was spoken by the multiple speakers 10 during the conversation based on the plurality of audio data segments 108. The speech recognition results 120 include the sequence of terms 204.

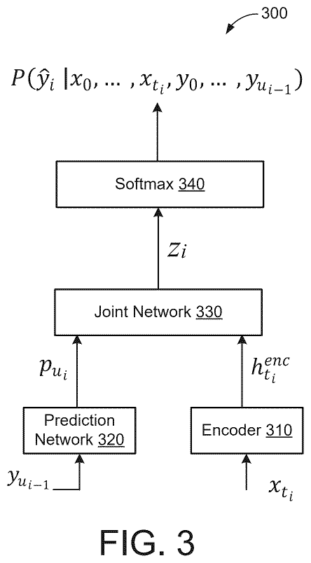

Referring now to FIG. 3, in some implementations, the ASR model 300 includes a Recurrent Neural Network-Transducer (RNN-T) model architecture which adheres to latency constraints with interactive applications. The use of the RNN-T model architecture is exemplary only, as the ASR model 300 may include other architectures such as transformer-transducer and conformer-transducer model architectures, among others. The RNN-T model provides a small computational footprint and utilizes less memory requirements than conventional ASR architectures, making the RNN-T model architecture suitable for performing speech recognition entirely on the user device 110 (e.g., no communication with a remote server is required). The RNN-T model architecture of the ASR model 300 includes an encoder network (e.g., audio encoder) 310, a prediction network 320, and a joint network 330. The encoder network 310, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, audio encoder 310 reads a sequence of d-dimensional feature vectors (e.g., audio data segments 108 (FIGS. 1A and 1B)) x=(x₁, x₂, . . . , x_{T}), where xₜ∈ [symbol] , and produces at each output step a higher-order feature representation (e.g., audio encoding). This higher-order feature representation is denoted as

$${h}_{1}^{enc} , … , {h}_{T}^{enc} .$$

Similarly, the prediction network 320 is also an LSTM network, which, like a language model (LM), processes the sequence of non-blank symbols output by a final Softmax layer 340 so far, y₀, . . . , yᵤᵢ₋₁, into a dense representation pᵤ_{ᵢ}. The prediction network 320 and the joint network 330 may collectively form the first decoder 350 of FIG. 2 that includes an RNN-T architecture. Finally, with the RNN-T model architecture, the representations produced by the encoder and prediction/decoder networks 310, 320 are combined by the joint network 330. The prediction network 320 may be replaced by an embedding look-up table to improve latency by outputting looked-up sparse embeddings in lieu of processing dense representations. The joint network 330 then predicts P(yᵢ|xₜ_{ᵢ}, y₀, . . . , yᵤ_{ᵢ}₋₁), which is a distribution over the next output symbol. Stated differently, the joint network 330 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 330 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 330 can include a posterior probability value for each of the different output labels. Thus, if there are 100 different output labels representing different graphemes or other symbols, the output yᵢ of the joint network 330 can include 100 different probability values, one for each output label. The probability distribution can then be used to select and assign scores to candidate orthographic elements (e.g., graphemes, wordpieces, and/or words) in a beam search process (e.g., by the Softmax layer 340) for determining the speech recognition result (e.g., transcription) 120 (FIG. 2).

The Softmax layer 340 may employ any technique to select the output label/symbol with the highest probability in the distribution as the next output symbol predicted by the ASR model 300 at the corresponding output step. In this manner, the ASR model 300 does not make a conditional independence assumption, rather the prediction of each symbol is conditioned not only on the acoustics, but also on the sequence of labels output so far. The ASR model 300 does assume an output symbol is independent of future acoustic frames 108, which allows the RNN-T model architecture of the ASR model 300 to be employed in the streaming fashion, the non-streaming fashion, or some combination thereof.

In some examples, the audio encoder 310 of the RNN-T model includes a plurality of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance, 16 layers. Moreover, the audio encoder 310 may operate in the streaming fashion (e.g., the audio encoder 310 outputs initial higher-order feature representations as soon as they are generated), in the non-streaming fashion (e.g., the audio encoder 310 outputs subsequent higher-order feature representations by processing additional right-context to improve initial higher-order feature representations), or in a combination of both the streaming and non-streaming fashion.

Referring back to FIG. 2, in some examples, the audio encoder 310 includes a stack of audio encoder layers 312, 314 having multi-head self-attention layers (e.g., conformer, transformer, convolutional, or performer layers) or a recurrent network of Long Short-Term Memory (LSTM) layers. For instance, the audio encoder 310 receives, as input, the sequence of acoustic frames 108 and generates, at each of the plurality of output steps, corresponding audio encoding 313, 315. More specifically, an initial stack of audio encoder layers 312 generates, at each output step, a corresponding sequence of intermediate audio encodings 313 from the sequence of acoustic frames 108. Thereafter, a remaining stack of the audio encoder layers 314 generates, at each output step, a corresponding sequence of final audio encodings 315 from the sequence of intermediate audio encodings 313. For example, the stack of audio encoder layers 312, 314 may include sixteen (16) conformer layers where the initial stack of audio encoder layers 312 (e.g., four (4) conformer layers) generates the corresponding sequence of intermediate audio encodings 313 from the sequence of acoustic frames 108 and the remaining stack of audio encoder layers 314 (e.g., the remaining twelve (12) conformer layers) generates the corresponding sequence of final audio encodings 315 from the corresponding sequence of intermediate audio encodings 313.

Notably, some information is discarded (e.g., background noise) as the initial stack of audio encoder layers 312 generates the sequence of intermediate audio encodings 313, but speaker characteristic information is maintained. Here, speaker characteristic information refers to the speaking traits or style of a particular user, for example, prosody, accent, dialect, cadence, pitch, etc. However, after generating the intermediate audio encodings 313, the speaker characteristic information may also be discarded as the remaining stack of audio encoder layers 314 generates the sequence of final audio encodings 315. That is, because the ASR model 300 is configured to predict “what” was spoken, the remaining stack of audio encoder layers 314 may filter out the speaker characteristic information (e.g., indicating voice characteristics of the particular user speaking) because voice characteristics pertaining to particular speakers are not needed to predict “what” was spoken and are only relevant when predicting “who” is speaking.

On the other hand, the diarization model 210 may leverage the speaker characteristic information to improve accuracy of predicting “who is speaking when,” because voice characteristics pertaining to particular speakers is helpful information when identifying who is speaking. Thus, because the sequence of intermediate audio encodings 313 includes the speaker characteristic information from the sequence of acoustic frames 108 (e.g., that may be subsequently discarded by the remaining stack of audio encoder layers 314), the intermediate audio encodings 313 advantageously enable the diarization model 210 to more accurately predict who is speaking each term (e.g., word, wordpiece, grapheme, etc.) of the speech recognition results 120. The first decoder 350 of the ASR model 300 is configured to receive, as input, the sequence of final audio encodings 315 generated by the remaining stack of audio encoder layers 314 and generate, at each of the plurality of output steps, a corresponding speech recognition result 120. The speech recognition result 120 may include a probability distribution over possible speech recognition hypotheses (e.g., words, wordpieces, graphemes, etc.). In some examples, the speech recognition results 120 include blank logits 121 denoting that no terms are currently being spoken at the corresponding output step. As will become apparent, the first decoder 350 may output the blank logits 121 and/or the speech recognition results 120 (not shown) to the second decoder 216 such that the second decoder 216 only outputs speaker tokens 206 when the first decoder 350 outputs non-blank speech recognition hypotheses 120.

The diarization model 210 is configured to generate, for each speech recognition result 120 generated by the first decoder 350 of the ASR model 300, a respective speaker token 206 representing a predicted identity of a speaker 10 from the multiple speakers 10 speaking during the conversation. Thus, the respective speaker tokens 206 generated by the diarization model 210 are word-level, wordpiece-level, or grapheme-level in connection with the ASR model 300 generating word-level, wordpiece-level, or grapheme-level speech recognition results 120, respectively. In particular, the diarization encoder 212 of the diarization model 210 receives, as input, the sequence of intermediate audio encodings 313 generated by the initial stack of audio encoder layers 312 and generates, at each of the plurality of output steps, a corresponding sequence of diarization encodings 213 from the sequence of the intermediate audio encodings 313. Notably, as discussed above, the sequence of intermediate audio encodings 313 may retain speaker characteristic information associated with the speaker 10 that is currently speaking to predict the identity of the speaker 10.

Optionally, the diarization encoder 212 may include a memory unit 214 that stores the previously generated diarization encodings 213 generated at prior output steps during the conversation. The memory unit 214 may include the memory hardware 114 from the user device 110 and/or the memory hardware 146 from the remote system 140. In particular, the diarization model 210 may include a recurrent neural network that has a stack of long short-term memory (LSTM) layers or a stack of multi-headed self-attention layers (e.g., conformer layers or transformer layers). Here, the stack of LSTM layers or multi-head self-attention layers act as the memory unit 214 and store the previously generated diarization encodings 213. As such, the diarization encoder 212 may generate, for a current output step, a corresponding diarization encoding 213 based on the previous diarization encodings 213 generated for the preceding output steps during the conversation. Advantageously, using the previous diarization encodings 213 provides the diarization model 210 more context in predicting which particular speaker 10 is currently speaking based on previous words the particular speaker 10 may have spoken during the conversation. In some implementations, the diarization model 210 includes a plurality of diarization encoders 212 (e.g., K number of diarization encoders) (not shown) whereby K is equal to the number speakers 10 speaking during the conversation. Stated differently, each diarization encoder 212 of the K number of diarization encoders 212 may be assigned to a particular one of the speakers 10 from the conversation. Moreover, each diarization encoder 212 of the K number of diarization encoders 212 is configured to receive a Kth intermediate audio encoding 313 from the audio encoder 310. Here, each of the Kth intermediate audio encodings 313 is associated with a respective one of the speakers 10 and is output to a corresponding diarization encoder 212 associated with the respective one of the speakers 10.

Thereafter, the second decoder 216 receives the sequence of diarization encodings 213 generated by the diarization encoder 212 and generates, for each respective speech recognition result 120 output by the ASR model 300, the respective speaker token 206 representing a predicted identity of the speaker 10 from the multiple speakers 10 that spoke the corresponding term from the speech recognition results 120. That is, the ASR model 300 may output speech recognition results 120 at each output step of the plurality of output steps such that the speech recognition results 120 include blank logits 121 where no speech is currently present. In contrast, the second decoder 216 is configured to receive the blank logits 121 and/or speech recognition results 120 (not shown) from the ASR model 300 whereby the second decoder 216 only generates speaker tokens 206 when the ASR model 300 generates speech recognition results 120 that include a spoken term. For example, for a conversation that includes ten (10) words, the second decoder 216 generates a corresponding ten (10) speaker tokens 206 (e.g., one speaker token for each word recognized by the ASR model 300).

Referring again to FIG. 1A, the LLM 160 aggregates and refines the series of short-form diarized transcripts 202 to generate a reconciled long-form diarized transcript 162. That is, the LLM 160 receives the sequential output of the speaker diarization model 200, which includes multiple short-form diarized transcripts 202, each corresponding to a distinct audio data segment 108. Stated differently, the LLM 160 generates the reconciled long-form diarized transcript 162 based on the corresponding short-form diarized transcript 202 generated for each respective audio data segment 108. Notably, generating the reconciled long-form diarized transcript 162 is not a simple concatenation of the short-form diarized transcripts 202. Instead, the LLM 160 performs a sequence-to-sequence transformation, mapping the fragmented short-form diarized transcripts 202 into the reconciled long-form diarized transcript 162. The sequence-to-sequence transformation allows the LLM 160 to consider the context of the entire conversation, rather than just individual segments. Thus, the long-form diarized transcript 162 represents the entire conversation captured by the plurality of audio data segments 108 with integrated speaker attribution. For example, if the audio data segments 108 represent a 30-minute meeting, the LLM 160 will compile the short-form transcripts from each 10-second segment into a single, comprehensive 30-minute transcript. As such, the LLM 160 is able to resolve inconsistencies in speaker identification that may be present between the short-form diarized transcripts 202.

In some implementations, the LLM 160 performs a reconciliation process, which may involve correcting inconsistencies or errors in speaker attribution, to generate the reconciled long-form diarized transcript 162. In particular, the LLM 160 is configured to analyze the context of the conversation and, when necessary, adjust the speaker tokens 206 within the short-form diarized transcripts 202. For instance, the LLM 160 may identify instances where the speaker diarization model 200 incorrectly assigned speaker identities. In such cases, the LLM 160 may rectify the speaker attribution errors by permuting, or swapping, a first speaker token 206 and a second speaker token 206 within at least one of the short-form diarized transcripts 202. The permutation ensures that the speaker attribution in the long-form diarized transcript 162 accurately reflects the actual speakers throughout the conversation. Beyond simple permutations, the LLM 160 may leverage understanding of conversational dynamics and speaker roles to refine speaker attribution. For example, if the LLM 160 recognizes a pattern of questions and answers, the LLM may infer that the same speaker is likely maintaining a consistent role throughout the conversation, even if the speaker diarization model 200 initially assigned different speaker tokens 206. Moreover, the LLM 160 may use the semantic context of the terms 204 spanning across the entire conversation to assist in determining the correct speaker token 206. For example, if one speaker consistently uses certain phrases or vocabulary, and those phrases appear in a segment with an ambiguous speaker token 206, the LLM 160 may use that information to correctly attribute the segment. The LLM 160 may also use contextual clues, such as if one speaker 10 is consistently referred to by name by other speakers 10.

Continuing with the example shown, the LLM 160 processes the first short-form diarized transcript 202a and the second short-form diarized transcript 202b to generate the reconciled long-form diarized transcript 162. The first short-form diarized transcript 202a includes a first sequence of terms 204, a first speaker token 206 attributing a first portion of the first sequence of terms 204 to a first speaker identity, and a second speaker token 206 attributing a second portion of the sequence of terms 204 to a second speaker identity. The second short-form diarized transcript 202b includes a second sequence of terms 204, the first speaker token 206 attributing a first portion of the second sequence of terms 204 to the first speaker identity, and the second speaker token 206 attributing a second portion of the second sequence of terms 204 to the second speaker identity. Notably, the first speaker token 206 and the second speaker token 206 are not consistent across the first short-form diarized transcript 202a and the second short-form diarized transcript 202b. For instance, the reconciled long-form diarized transcript 162 is “<spk1> hello Adam <spk2> how are you? <spk1> pretty good, how are you? <spk2> good <spk1> how are your kids, Adam? <spk2> they are doing great.” Notably, the LLM 160 permutes the first speaker token 206 (e.g., <spk1>) and the second speaker token 206 (e.g., <spk2>) of the second short-form diarized transcript 202b. The LLM 160 performs this permutation using contextual understanding of the conversation by determining that the speaker identified as “<spk2>” in the second short-form diarized transcript 202b is the same speaker identified as “<spk1>” in the first short-form diarized transcript 202a, and vice-versa. As a result, the speaker tokens 206 in the reconciled long-form diarized transcript 162 are consistent throughout the entire conversation. This consistency ensures that the same speaker is consistently referred to by the same speaker token 206 throughout the entire diarized transcript, improving the accuracy and readability of the transcript.

In some implementations, the joint speech recognition and diarization model 150 generates a prompt 102 that the LLM 160 processes in addition to the short-form diarized transcripts 202. The prompt 102 provides instructions and context to the LLM 160, guiding the LLM 160 how to process the short-form diarized transcripts 202. For example, the prompt 102 may include “Below are speaker attributed transcript from multiple continuous segments. However, the speaker tokens are not consistent across segments. Please update the speaker tokens in this way. First, within each segment, permute speaker tokens if needed. Second, ensure that the speaker tokens are consistent with the global semantic context.” Here, the prompt 102 explicitly instructs the LLM 160 to perform two key functions. First, intra-segment correction, where speaker tokens 206 within a single short-form diarized transcript 202 may be reordered if necessary to match the local context. Second, inter-segment consistency, where speaker tokens 206 may be adjusted across one or more short-form diarized transcripts 202 to ensure a globally consistent and accurate speaker attribution throughout the entire conversation. Moreover, the instruction to consider the “global semantic context” encourages the LLM 160 to leverage understanding of language and conversation to identify and correct errors that may arise from relying solely on the short-form diarized transcripts 202 in isolation. By providing the short-form diarized transcripts 202 and the prompt 102, the LLM 160 may correct the short-form diarized transcripts 202 by generating the reconciled long-form diarized transcript 162.

Referring now to FIG. 1B, in some implementations, the joint speech recognition and diarization model 150 of a second example system 100, 100b includes the ASR model 300 and the sequence processing neural network (e.g., LLM) 160. As described above, the ASR model 300 is configured to generate a transcription 120 that includes the sequence of terms 204 based on the plurality of audio data segments 108. The ASR model 300 does not, itself, perform speaker diarization. Instead, the LLM 160 leverages the output of the ASR model 300 (e.g., the transcription 120) and previously generated diarized transcripts 164 to perform speaker diarization. For each term subsequent to an initial term 204, the LLM 160 obtains prior diarized transcripts 164 and determines a corresponding diarized transcript 164 based on the respective term 204 and the prior diarized transcripts 164. In other words, the LLM 160 receives a non-diarized transcription 120 from the ASR model 300, and progressively builds a diarized transcript 164, term by term, using the current term 204 from the transcription 120 and the context from previously processed and diarized terms (e.g., the prior diarized transcripts 164).

Each diarized transcript 164 includes a sequence of terms 204 and one or more speaker tokens 206. The sequence of terms 204 indicates “what” was spoken during the conversation and the speaker tokens 206 indicate “who” spoke each term 204. In some examples, the speaker tokens 206 include word-level results that represent who spoke each word/wordpiece rather than frame-level results that represent who was speaking during each frame of the sequence of acoustic frames 108. In other examples, the speaker tokens 206 include frame-level results that represent who was speaking during each frame of the sequence of acoustic frames 108. The LLM 160 uses the prior diarized transcript 164 to provide historical context for making speaker attributions. This may include considering which speaker 10 spoke before the current term 204, the overall topic of conversation, and any known relationships between speakers 10.

In some implementations, the joint speech recognition and diarization model 150 generates a prompt 102 that the LLM 160 processes in addition to the transcription 120 with the sequence of terms 204 and the prior diarized transcripts 164. The prompt 102 provides instructions and context to the LLM 160, guiding the LLM 160 to perform diarization. For example, the prompt 102 may instruct the LLM 160 to prioritize maintaining consistent speaker identities across turns, or to consider the semantic context of the conversation when assigning speaker tokens 206. The prompt 102 may also define the format of the speaker tokens 206 (e.g., “<Speaker_A>”, “[SPK1]”) or specify any known information about the speakers 10 (e.g., names, roles).

In some examples, the LLM 160 obtains a text input 104 from a speaker 10 in the conversation or another user observing or monitoring the conversation. The text input 104 is captured during the conversation and may represent various types of information, such as notes, summaries, action items, or corrections to the recognized speech. For example, in a scenario where a journalist is interviewing a subject, the journalist may use a device (e.g., a tablet, laptop, or smartphone) to take shorthand notes during the interview. Here, the notes would represent the text input 104. In another example, in a scenario where participants are in a meeting, one or more of the participants may use a meeting application on a device to take notes during the meeting. These notes may be taken while other participants are speaking. Here, these notes, captured in real-time, would represent the text input 104.

The LLM 160 treats the text input 104 as an independent input stream that is separate from the transcription 120 and prior diarized transcripts 164. To that end, the LLM 160 processes the text input 104 in conjunction with the transcription 120 and the prior diarized transcripts 164 to enhance the diarization and transcription process. For instance, the LLM 160 may incorporate the text input 104 into the diarized transcript 164 by timestamping the text input 104 with the time of capture relative to the ongoing conversation. The timestamp allows the LLM 160 to correlate the text input 104 with the corresponding segment of the audio data and transcribed speech.

Moreover, the LLM 160 may diarize the text input 104 itself. In the journalist example, the LLM 160 would attribute the notes to the journalist (e.g., “<Journalist> Note: Subject seems nervous.”), thus indicating who created the text input 104. In the meeting example, the LLM 160 would attribute the notes to the meeting participant who entered them (e.g., “<participant_A> Note: need to follow up on budget.”) This indicates who created the text input 104. The LLM 160 may also annotate the text input 104 to the overall transcription of the diarized transcript 164, meaning that the text input 104 included in the final transcript, linked to the specific point in the conversation where the text input 104 was entered. The annotation may take various forms, such as displaying the notes in a separate pane alongside the diarized transcript 164, inserting the notes inline within the diarized transcript 164 (potentially in a different font or style to distinguish it from the spoken audio), or using a pop-up window that appears when the user 10 hovers over or clicks on a timestamp. An example annotation in the diarized transcript 164 may be “<Timestamp: 10:23> <Journalist> Note: Subject evading the question about finances.”

In some examples, the LLM 160 may use the content of the text input 104 to improve overall speaker diarization accuracy and/or improve the accuracy of the transcription 120 itself. For instance, if the notes taken by the journalist include information such as “Subject A denies involvement,” the LLM 160 may use this to confirm or correct the speaker attribution in the audio transcript, especially if the audio-based diarization was uncertain. Similarly, if the text input 104 includes a verbatim quote or a correction to a misheard word, the LLM 160 may incorporate this information to refine the sequence of terms 204 in the transcription 120.

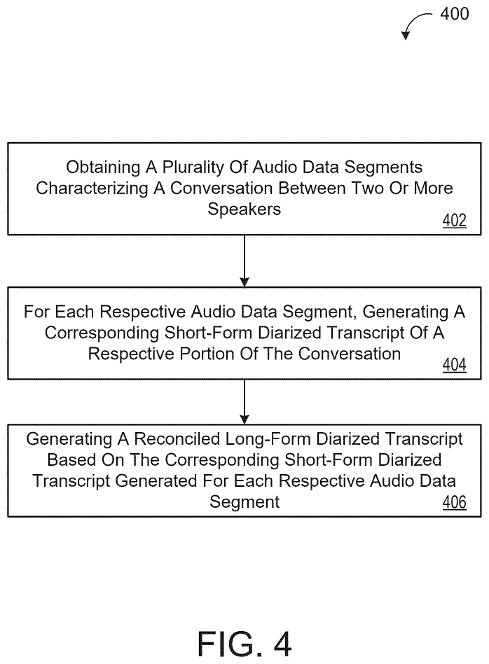

FIG. 4 includes a flowchart of an example arrangement of operations for a computer-implemented method 400 of reconciling speaker permutation in longform speaker diarization. The method 400 may execute on data processing hardware 610 (FIG. 6) using instructions stored on memory hardware 620 (FIG. 6) that may reside on the user device 110 and/or the remote system 140 of FIG. 1 corresponding to a computing device 600 (FIG. 6).

At operation 402, the method 400 includes obtaining a plurality of audio data segments 108 characterizing a conversation between two or more speakers 10. At operation 404, the method 400 includes, for each respective audio data segment 108, generating, using a speaker diarization model 200, a corresponding short-form diarized transcript 202 of a respective portion of the conversation. The corresponding short-form diarized transcript 202 includes a respective sequence of terms 204 and a respective one or more speaker tokens 206 attributing each of the sequence of terms to a corresponding speaker identity. At operation 406, the method 400 includes generating, using a sequence processing neural network 160, a reconciled long-form diarized transcript 162 based on the corresponding short-form diarized transcript 202 generated for each respective audio data segment 108. The sequence processing neural network 160 generates the reconciled diarized transcript 162 by, for one of the corresponding short-form diarized transcripts 202, permuting a first speaker token 206 and a second speaker token 206 of the one of the corresponding short-form diarized transcripts 202.

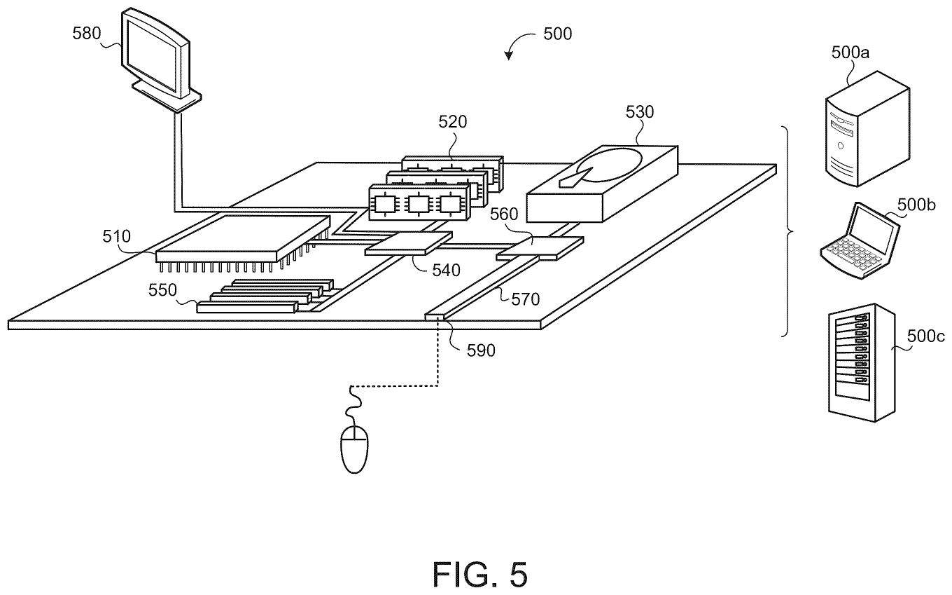

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a plurality of audio data segments characterizing a conversation between two or more speakers;
for each respective audio data segment, generating, using a speaker diarization model, a corresponding short-form diarized transcript of a respective portion of the conversation, the corresponding short-form diarized transcript comprising:
a respective sequence of terms; and
a respective one or more speaker tokens attributing each of the sequence of terms to a corresponding speaker identity; and
generating, using a sequence processing neural network, a reconciled long-form diarized transcript based on the corresponding short-form diarized transcript generated for each respective audio data segment,
wherein the sequence processing neural network generates the reconciled diarized transcript by, for one of the corresponding short-form diarized transcripts, permuting a first speaker token and a second speaker token of the one of the corresponding short-form diarized transcripts.

2. The computer-implemented method of claim 1, wherein the one of the corresponding short-form diarized transcript comprises:
a first sequence of terms;
the first speaker token attributing a first portion of the first sequence of terms to a first speaker identity; and
the second speaker token attributing a second portion of the sequence of terms to a second speaker identity.

3. The computer-implemented method of claim 2, wherein another one of the corresponding short-form diarized transcript comprises:
a second sequence of terms;
the first speaker token attributing a first portion of the second sequence of terms to the first speaker identity; and
the second speaker token attributing a second portion of the second sequence of terms to the second speaker identity,
wherein the first speaker token and the second speaker token are not consistent across the one of the corresponding short-form diarized transcript and the other one of the corresponding short-form diarized transcript.

4. The computer-implemented method of claim 3, wherein the reconciled diarized transcript permutes the first speaker token and the second speaker token such that the first speaker token and the second speaker token are consistent across the one of the corresponding short-form diarized transcript and the other one of the corresponding short-form diarized transcript.

5. The computer-implemented method of claim 1, wherein the sequence processing neural network permutes the first speaker token and the second speaker token of the one of the corresponding short-form diarized transcripts based on semantic context spanning across the conversation.

6. The computer-implemented method of claim 1, wherein the operations further comprise:
for each respective audio data segment, generating, using an automatic speech recognition model, a corresponding transcription comprising one or more terms; and
for each respective term of the one or more terms:
obtaining prior diarized transcripts; and
generating, using the sequence processing neural network, a corresponding diarized transcript based on the respective term and the prior diarized transcript.

7. The computer-implemented method of claim 6, wherein the operations further comprise:
obtaining a text input representing notes taken during the conversation,
wherein generating the corresponding diarized transcript is further based on the text input.

8. The computer-implemented method of claim 7, wherein the operations further comprise timestamping the text input with a time of capture relative to the conversation.

9. The computer-implemented method of claim 7, wherein operations further comprise diarizing, using the sequence processing neural network, the text input.

10. The computer-implemented method of claim 9, wherein the operations further comprise annotating, using the sequence processing neural network, the text input to the long-form diarized transcript.

11. A system comprising:
data processing hardware; and
memory hardware in communication with the data processing hardware, the memory hardware storing instructions that when executed on the data processing hardware cause the data processing hardware to perform operations comprising:
obtaining a plurality of audio data segments characterizing a conversation between two or more speakers;
for each respective audio data segment, generating, using a speaker diarization model, a corresponding short-form diarized transcript of a respective portion of the conversation, the corresponding short-form diarized transcript comprising:
a respective sequence of terms; and
a respective one or more speaker tokens attributing each of the sequence of terms to a corresponding speaker identity; and
generating, using a sequence processing neural network, a reconciled long-form diarized transcript based on the corresponding short-form diarized transcript generated for each respective audio data segment,
wherein the sequence processing neural network generates the reconciled diarized transcript by, for one of the corresponding short-form diarized transcripts, permuting a first speaker token and a second speaker token of the one of the corresponding short-form diarized transcripts.

12. The system of claim 11, wherein the one of the corresponding short-form diarized transcript comprises:
a first sequence of terms;
the first speaker token attributing a first portion of the first sequence of terms to a first speaker identity; and
the second speaker token attributing a second portion of the sequence of terms to a second speaker identity.

13. The system of claim 12, wherein another one of the corresponding short-form diarized transcript comprises:
a second sequence of terms;
the first speaker token attributing a first portion of the second sequence of terms to the first speaker identity; and
the second speaker token attributing a second portion of the second sequence of terms to the second speaker identity,
wherein the first speaker token and the second speaker token are not consistent across the one of the corresponding short-form diarized transcript and the other one of the corresponding short-form diarized transcript.

14. The system of claim 13, wherein the reconciled diarized transcript permutes the first speaker token and the second speaker token such that the first speaker token and the second speaker token are consistent across the one of the corresponding short-form diarized transcript and the other one of the corresponding short-form diarized transcript.

15. The system of claim 11, wherein the sequence processing neural network permutes the first speaker token and the second speaker token of the one of the corresponding short-form diarized transcripts based on semantic context spanning across the conversation.

16. The system of claim 11, wherein the operations further comprise:
for each respective audio data segment, generating, using an automatic speech recognition model, a corresponding transcription comprising one or more terms; and
for each respective term of the one or more terms:
obtaining prior diarized transcripts; and
generating, using the sequence processing neural network, a corresponding diarized transcript based on the respective term and the prior diarized transcript.

17. The system of claim 16, wherein the operations further comprise:
obtaining a text input representing notes taken during the conversation,
wherein generating the corresponding diarized transcript is further based on the text input.

18. The system of claim 17, wherein the operations further comprise timestamping the text input with a time of capture relative to the conversation.

19. The system of claim 17, wherein operations further comprise diarizing, using the sequence processing neural network, the text input.

20. The system of claim 19, wherein the operations further comprise annotating, using the sequence processing neural network, the text input to the long-form diarized transcript.
